(19) United States
(12) Patent Application Publication
(10) Pub. No.: US 2009/0224187 A1
(43) Pub. Date: Sep. 10, 2009

(54) COUNTING DEVICE FOR SMALL SERIES

(75) Inventors: Benoit Berthe, Orleans (FR); Dominique Perdoux, Mardie (FR)

Correspondence Address: LOWE HAUPTMAN HAM & BERNER, LLP, 1700 DIAGONAL ROAD, SUITE 300, ALEXANDRIA, VA, 22314, US

(73) Assignee: DATACARD CORPORATION, Minnetonka (US)

(21) Appl. No.: 12/097,792

(22) PCT Filed: Dec. 19, 2006
(86) PCT No.: PCT/IB06/03677

§ 371 Date: Oct. 23, 2008

(30) Foreign Application Priority Data
Dec. 19, 2005 (FR) 05 12904

(51) Int. Cl. G06M 9/00; G01V 8/10

(52) U.S. Cl. 250/559.04

(57) ABSTRACT

The invention concerns a device for counting series of thin products (2), stacked side by side, and includes a means of illuminating the stack (5) producing one or more light beams covering the whole length of the stack (5), —a detection resource with a detection circuit, including a multiplicity of photosensitive elements, an optical device, associated with the detection circuit, that can be used to focus light rays reflected by the stack (5), —storage resources a separating element (1) included in the stack (5) between two adjacent series of thin products (2), where each separating element (1) has a mark placed on one part of one of its edges where a part of the marking is illuminated by a lighting resource and visible to the detection resource; —processing resources receiving signals coming from the detection circuit and arranged so as to distinguish the visual limit of the thin products (2) as well as the mark on the separating element (1).

The invention concerns the area of appliances for the counting of thin products stacked side by side to form small series. More particularly, it concerns counting the number of thin products contained in a batch of small series, automatically and at a good speed.

There already exist counting appliances as described in French patent 2 718 550 dated Oct. 13, 1995, entitled “Dispositif de comptage de produits” (products counting device). This device allows the counting of large series of thin products stacked side by side.

There also already exist counting appliances as described in French patent 2 854 476 dated Apr. 30, 2003, entitled “Dispositif de comptage de produits empilés” (Counting device for stacked products). This device, of relatively small dimensions, also allows the counting of large series of thin products stacked side by side.

However, these appliances are not suitable for the automatic counting of small series, since they cannot be used to count the number of elements in small series automatically and at a good speed. The counting of thin products generally forms part of a production line, before physical or software personalisation operations or packaging operations for example. Currently, the counting of the thin products forming small series, such as series of personalisable cards of fifteen or so elements, is in fact performed by hand, since this counting method gives the best efficiency. There is currently no suitable device with a counting speed for small sequences that is better than that attained by hand.

This present invention therefore has as its purpose to overcome one or more drawbacks of the previous art, by creating a device that can be used to count the number of thin products produced in small series, automatically and at a good speed.

This objective is attained by means of a device for counting series of thin products, stacked side by side, in a specified direction in a support resource, where the thin products form a stack, and the device includes the following at least:
a means of illuminating the stack, by producing one or more light beams covering at least the whole length of the stack,
a detection resource with at least one detection circuit that includes a multiplicity of photosensitive elements and at least one optical device, associated with the detection circuit, that can be used to focus light rays reflected by the stack,
storage resources,
   the device for counting further comprising:
at least one separating element, included in the stack at least between two adjacent series of thin products, where each separating element has at least one mark placed on at least one part of one of its edges, where at least one part of the mark is illuminated by at least one lighting resource and visible to at least one detection resource;
processing resources receiving signals coming from the detection circuit or circuits, and arranged so as to distinguish the visual limit of the thin products, as well as the mark on the said separating element.

According to another particular feature, the processing resources associated with the detection resources perform a longitudinal analysis of the stack in order to determine the number of elements in each series constituting the stack, or information that can be used to deduce the number of elements in each series constituting the stack.

According to another particular feature, the processing resources associated with the detection resources perform a longitudinal analysis of the stack in order to determine the position of each separating element in the stack.

According to another particular feature, a CIS module, positioned longitudinally and opposite to the stack, constitutes both lighting resources and detection resources, where the length of the CIS module is at least equal to that of the stack, or where the CIS module effects movements in the longitudinal direction of the stack opposite to a zone covering at least the whole length of the stack in several stages.

According to another particular feature, the device includes a multiplicity of CIS modules, positioned longitudinally and opposite to the stack, where each CIS module includes detection resources and resources for lighting by means of a flat beam in the specified direction, where the sum of the lengths of the CIS modules is at least equal to the length of the stack.

According to another particular feature, the CIS modules illuminate the stack along an illumination line, with each CIS module being inclined at an angle determined so that its flat light beam falls upon this line.

According to another particular feature, the lighting resources include at least one focussing device and a multiplicity of electroluminescent diodes producing a flat beam in the specified direction, and the detection resources include two mirrors and a CCD camera, with the part of the stack illuminated by the lighting resources being reflected toward the CCD camera by the mirrors.

According to another particular feature, the lighting resources include a fluorescent tube illuminating the top face of the stack, and the detection resources include two mirrors and a CCD camera, with part of the illuminated zone of the stack being reflected toward the CCD camera by the mirrors.

According to another particular feature, the device includes resources for relative transverse movement of the support resource in relation to the detection and lighting resources, allowing a multiplicity of longitudinal analyses of different zones of the stack.

According to another particular feature, the detection circuit of the CCD camera is composed of a matrix of photosensitive elements, whose width allows the execution of a multiplicity of longitudinal analyses of different zones of the stack.

According to another particular feature, the device includes at least one transverse CIS module, positioned transversally and opposite to the stack, with the said transverse CIS module including detection resources and resources for illumination by means of a beam covering at least one part of the width of the stack, with the transverse CIS module effecting a movement in the specified direction, opposite to a zone covering at least the whole length of the stack.

According to another particular feature, the transverse CIS module includes a multiplicity of photosensitive elements placed transversally in relation to the stack, and that can be used to effect a multiplicity of longitudinal analyses of different zones of the stack.

According to another particular feature, the mark on a separating element is effected on its edge, by two dark or light stripes, on light or dark backgrounds respectively, these stripes being of specified thickness, of the same length as the separating element, and distant by an equal length firstly from one long side of the separating element and secondly from the other stripe.

According to another particular feature, the marking on a separating element is placed on its edge, in the form of several dark or light stripes, on light or dark backgrounds respectively, these stripes being of specified thickness, of the same length as the separating element, equidistant from each other or from one long edge of the separating element and the adjacent stripe.

According to another particular feature, the mark on a separating element is placed on its edge, in the form of a dark or light stripe, on light or dark backgrounds respectively, with the stripe being of a specified thickness, of the same length as the separating element, and equidistant from the long sides of the separating element.

According to another particular feature, the mark on a separating element is effected by a black or dark stripe adjacent to a white or light stripe printed on the edge of the separating element in the direction of the longest length, of the same length as the separating element and each occupying one half of the width of the separating element.

According to another particular feature, the mark on a separating element is effected by a barcode and/or by a dot code, of the same length as the separating element.

According to another particular feature, the stack includes separating elements with different or identical marks.

According to another particular feature, at least one separating element includes a distinguishing pattern on at least one face, that can be identified by a personalising machine.

According to another particular feature, a multiplicity of longitudinal analyses are effected on a given zone of the stack, with the lighting resources producing one or more beams with a distinct given intensity for each longitudinal analysis.

According to another particular feature, the storage resources store the different coding configurations of the separating elements, with each configuration corresponding to an identifier for a series of thin products, and the processing resources are used to compare signals coming from the detection circuit or circuits with the configurations stored in the storage resources, and to associate one of the identifiers of a series of thin products with at least one series in the stack.

According to another particular feature, the two black stripes, analysed by the processing resources, are used to determine the width of the edge of a thin product and/or of a separating element.

Another aim is the use of a counting system that employs series separating elements in order to allow the adaptation of certain production operations according to the batch concerned, and to follow-up each batch continuously.

This aim is attained by the use of a counting device by which information is transmitted by the processing resources, via communication resources, to a processing system of the personalising machine type, downstream of a production line, where the transmitted information includes the number of elements in each series constituting the stack, and/or information that can be used to deduce the number of elements in each series constituting the stack and/or the position of each separating element in the stack and/or the identifier for each series.

According to another particular feature, the processing system personalises the products in the series, with the physical or software personalisation operations to be applied to each element of a series being associated with the information transmitted by the processing resources.

According to another particular feature, the processing system distinguishes the separating elements by means of the information transmitted by the processing resources, ejects the separating elements before the processing of a new series, and stores them with a view to their reuse.

Another aim is the use of a counting system that employs series separating elements in order to allow identification of the elements of the stack.

This aim is attained by the use of the counting device with which, since the stack is created with several types of separating element, each type of separating element is chosen so as to identify one of the two series between which the separating element is inserted.

Another aim is the use of a counting system that employs series separating elements in order to allow electronic programming of the thin products to be counted.

This aim is attained by the use of the counting device associated with a digital personalising station, processing a series of thin products including an integrated circuit, allowing storage, in the memory of the integrated circuit, of personalising information for the use for which the product is intended.

The invention, its characteristics and its advantages will appear more clearly on reading the following description, which is given with reference to the figures described below:

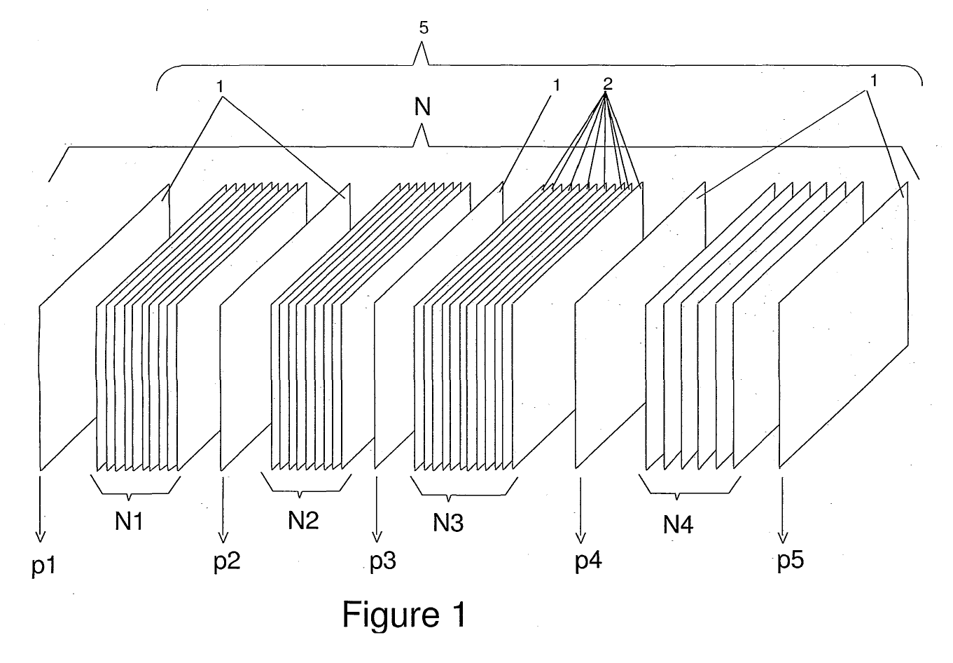

FIG. 1 is an exploded view, in perspective, showing the series separated by separating elements and assembled into a stack.

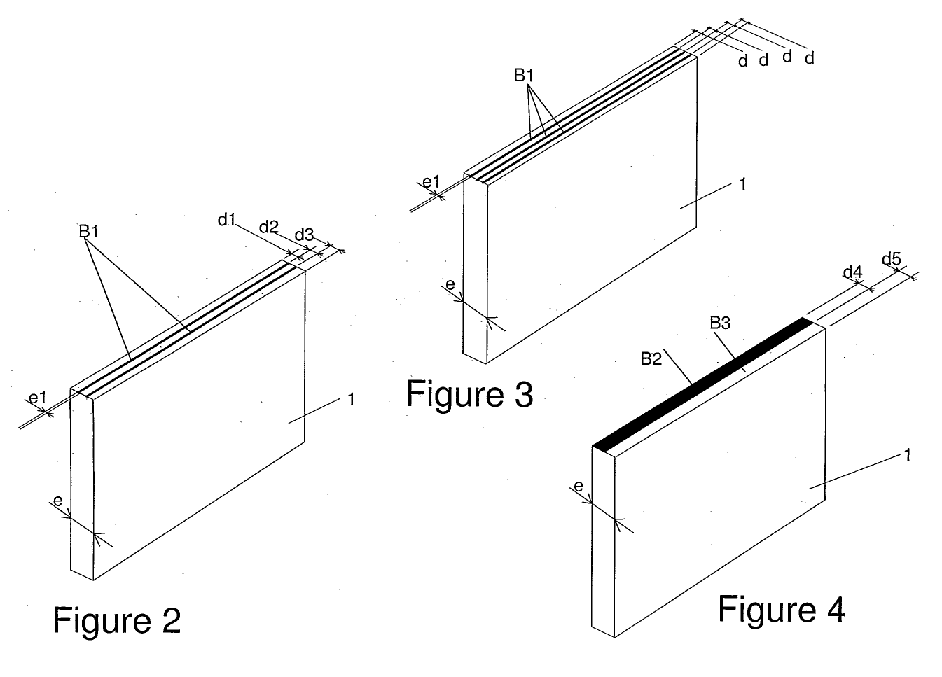

FIGS. 2 and 3 are views in perspective, showing examples of marks on separating elements, of the type with longitudinal black lines on a white background.

FIG. 4 is a view in perspective showing an example of a mark on a separating element, of the black/white transition type, printed on the edge of a separating element.

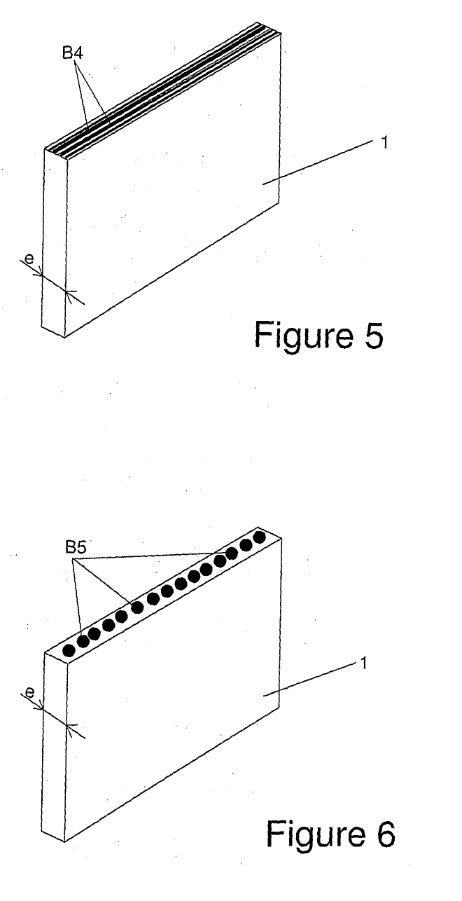

FIG. 5 is a view in perspective showing an example of a mark on a separating element, of the barcode type.

FIG. 6 is a view in perspective showing an example of a mark on a separating element, of the dot code type.

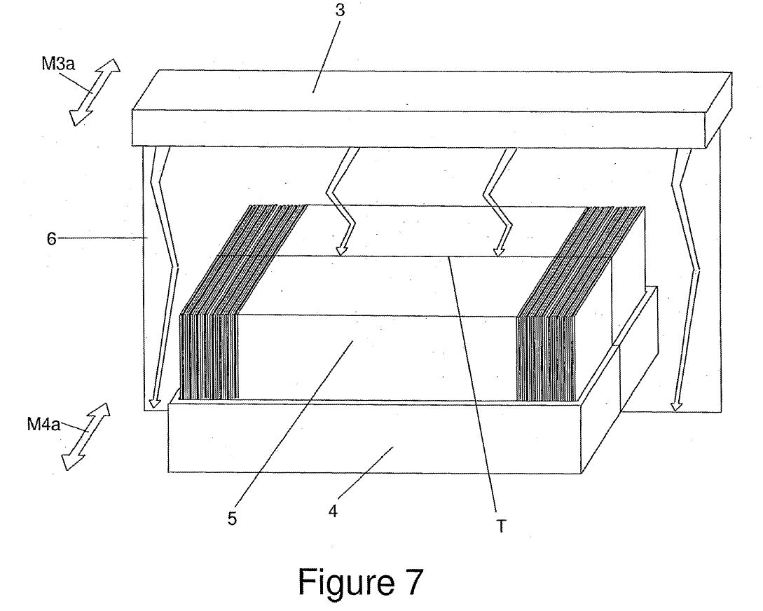

FIG. 7 is a view in perspective showing an example of a counting device with one CIS module covering the whole stack;

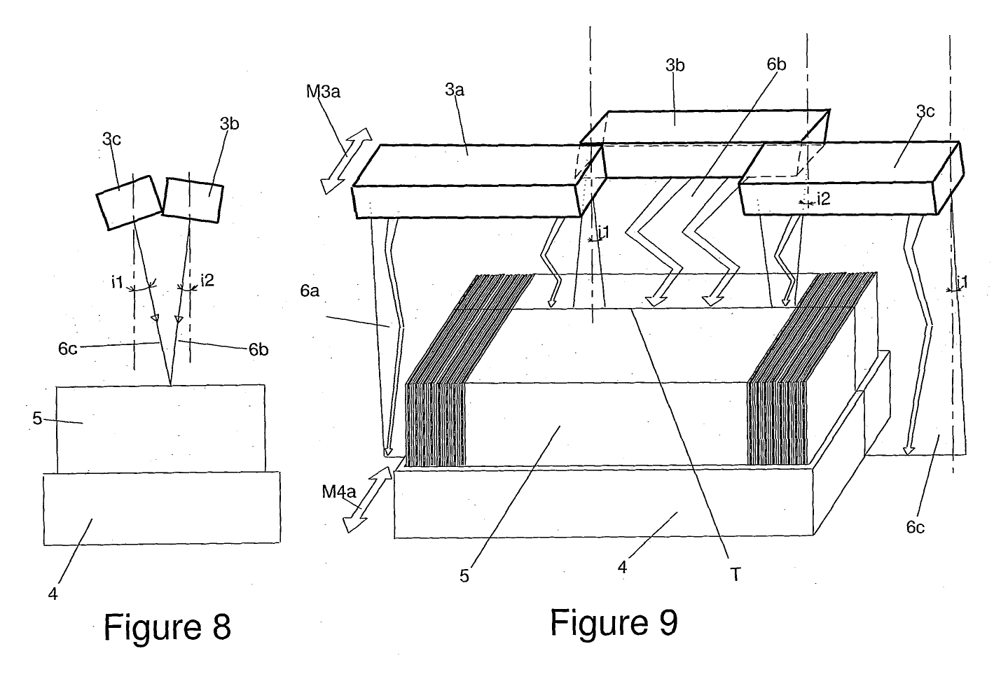

FIGS. 8 and 9 are respectively a side view and a view in perspective showing an example of a counting device with several CIS modules covering the whole stack;

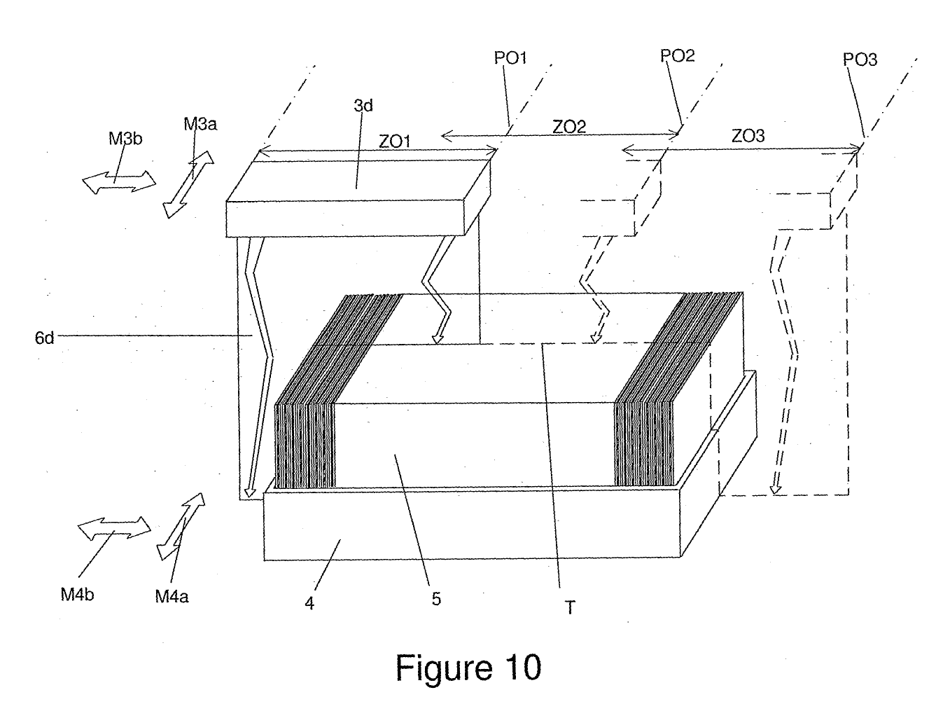

FIG. 10 is a view in perspective showing an example of a counting device with one CIS module covering the whole stack by longitudinal movements;

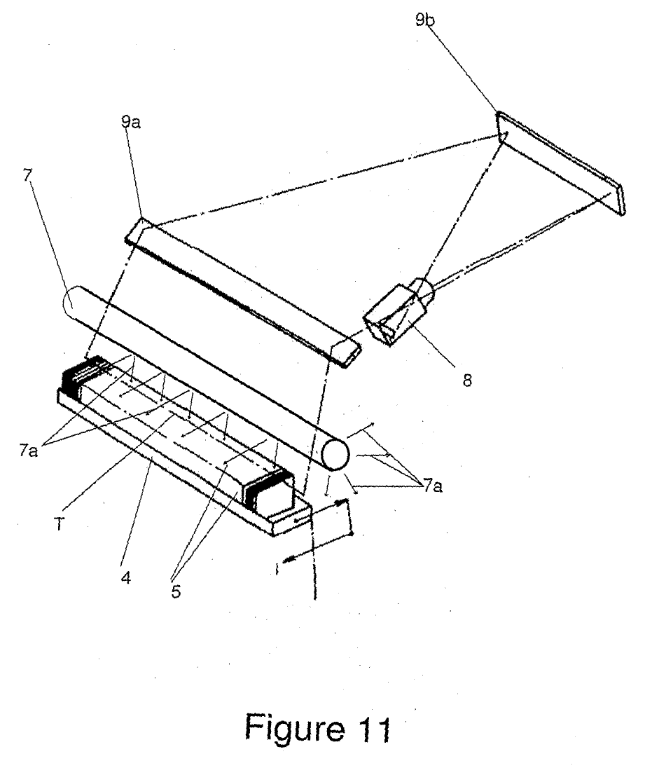

FIG. 11 is a view in perspective showing an example of a counting device with a CCD camera;

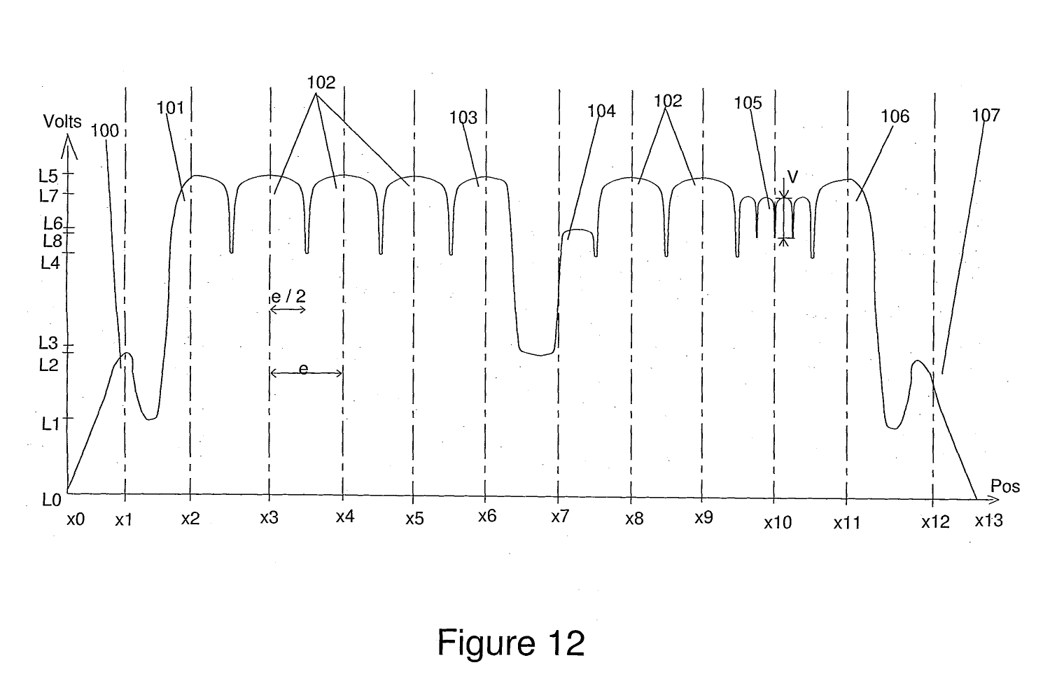

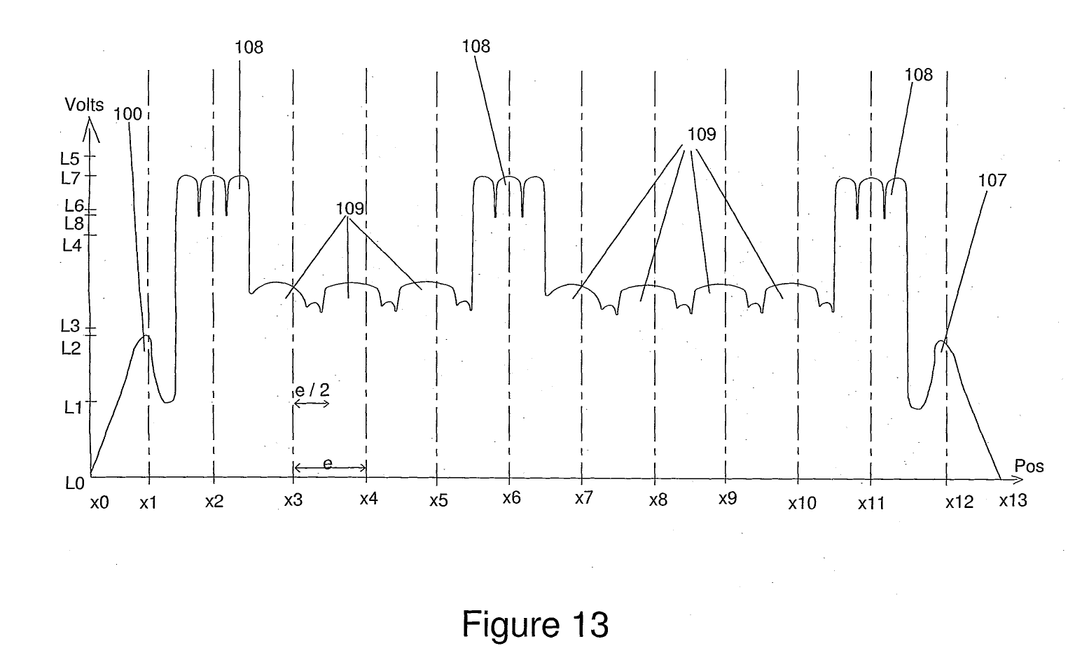

FIGS. 12 and 13 show non-limiting examples of graphs of the signal amplitudes produced by the photosensitive elements;

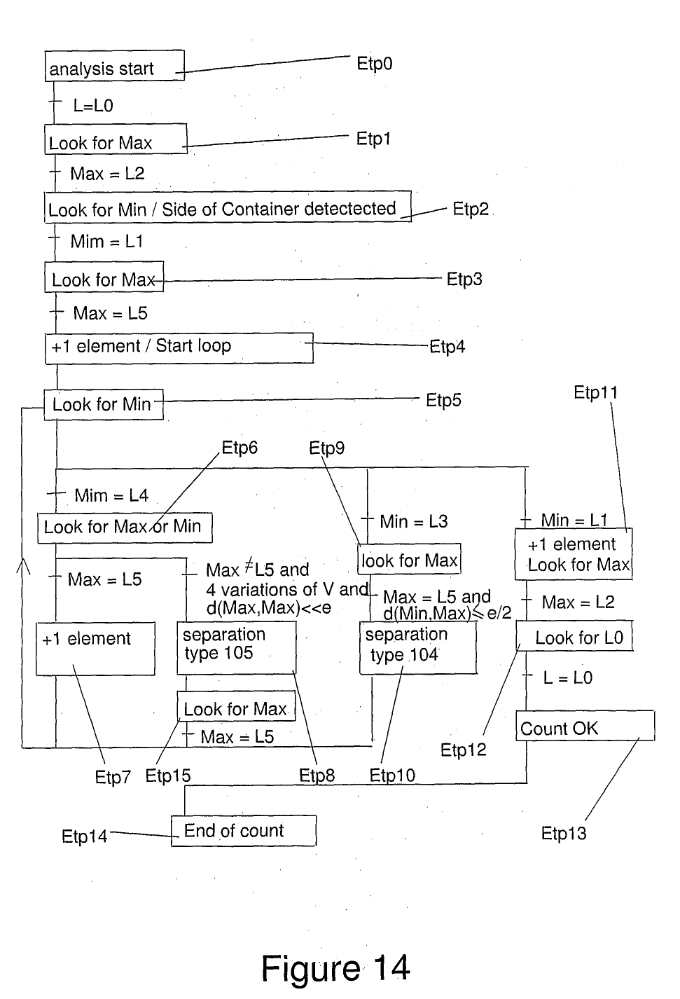

FIG. 14 shows an example of a data-processing flow diagram;

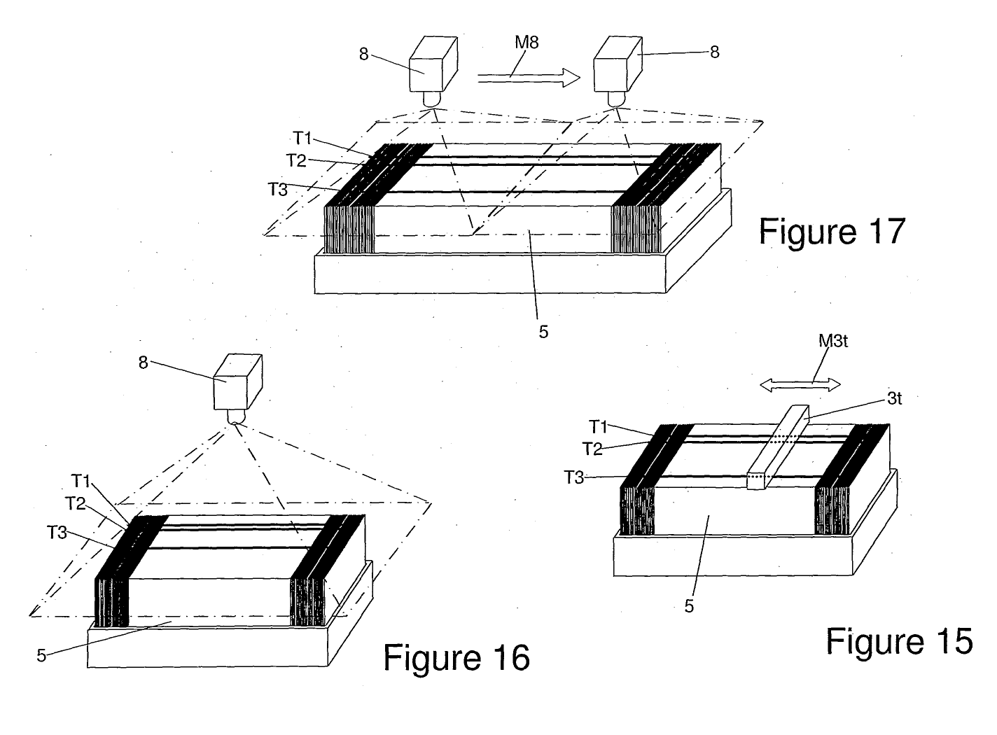

FIG. 15 shows an example of a counting device with one transverse CIS module effecting a longitudinal analysis movement;

FIG. 16 shows an example of a counting device with a CCD matrix-type camera performing longitudinal along several longitudinal analyses lines;

FIG. 17 shows an example of a counting device with a CCD matrix-type camera performing one or more longitudinal analyses by a movement in the longitudinal direction.

The invention will now be described with reference to FIGS. 1 to 17. FIGS. 7 to 10 show a counting device with one or more CIS modules (3, 3a, 3b, 3c, 3d), positioned longitudinally. A CIS module (3, 3a, 3b, 3c, 3d) includes integrated lighting resources, a photosensitive cell and an optical focussing device. FIG. 11 represents a counting device with a lighting resource (7), mirrors (9a, 9b) and a CCD camera (8). Other cameras, of the same type, with an optical device and a photosensitive circuit, and producing an electrical signal in accordance with the light received, are also usable. The device includes a rectangular container (4) which holds the thin elements (1, 2), with only the elements (1, 2) at the ends of the stack (5) being represented in FIGS. 7 to 11. The thin elements are held, in a manner which is non-limiting, by a removable transparent film or by spacers resting on the container (4). The container (4) serves, in a manner which is non-limiting, as a support resource for the thin products. In another method of implementation, a magazine used in the processing of the thin products is used directly. The stack (5) is illuminated, over all of its length, by a flat beam of light rays (6, 6a, 6b, 6c, 6d) produced by the lighting resources of a CIS module (3, 3a, 3b, 3c, 3d) or by a diode-type lighting resource whose rays are focussed onto a plane by an optical device. The flat beam (6, 6a, 6b, 6c, 6d) projected against the stack (5) produces a luminous line (T). The line (T) is then analysed by resources (3, 3a, 3b, 3c, 3d, 9a, 9b, 8) for detection of the reflected light intensity, associated with processing resources. In another method of implementation, the lighting resources include a fluorescent tube (7), which illuminates, by multidirectional rays (7a), all the top part of the stack (5), including the zone of the aforementioned luminous line (T), analysed by the detection resources associated with the processing resources. In this present description, the analysis of a longitudinal luminous line (T) by the detection resources (3, 3a, 3b, 3c, 3d, 9a, 9b, 8) associated with the processing resources is called longitudinal analysis of the stack (5). The analyse of several segments of the stack (5), over all of its length, by the processing resources associated with the detection resources, is also described as a longitudinal analysis.

The light rays (6, 6a, 6b, 6c, 6d) emitted by the light source or sources allow a longitudinal analysis of the batch of products, meaning parallel to the long side of the container (4). The relative movement of the container in relation to the CIS module or modules is transverse, meaning parallel to the small side of the container, and involves longitudinal analyses over different longitudinal zones. The longitudinal luminous line (T) is in fact moved to different levels according to the width of the stack (5). As an example, 100 longitudinal analyses are performed in one transverse side-to-side, go-and-return movement (M4a, M3a). In another method of implementation, different longitudinal analyses are effected by transverse movements that are not perpendicular to the longitudinal direction of the line (T) on the stack (5). In another method of implementation a fluorescent tube (7), more powerful than diodes, illuminates all the top part of the stack (5). In this case, a matrix-type photosensitive cell, such as a CCD matrix for example, can simultaneously perform longitudinal analyses over different longitudinal zones without relative movement of the container (4) in relation to the lighting and detection resources.

A CIS module (3, 3a, 3b, 3c, 3d) or the CCD camera (8) are connected to a processing circuit in order to transmit the electrical signals resulting from conversion of the light energy into electrical energy by the photosensitive cells. The electrical signals produced contain information for each pixel of the CIS or CCD photosensitive cell. The electrical information is generally converted into levels, which are digitised and held in the storage resources. The memorising and storing stages, which are already described in French patent 2854476 dated Apr. 30, 2003 entitled “Counting device for stacked products”, will not be described in this patent. By way of an example each CIS or CCD photosensitive cell includes 10,000 photosensitive elements, to analyse the whole length of the stack (5) and allow the counting of a product batch of some 1000 products at most, for example. Each photosensitive element is used to detect a light signal and to express this signal in the form of an electrical signal representing at least 256 light levels. This signal, representing 256 light levels is converted into 8-bit words, and each word is recorded in the memory of the device. Thus for the example given, the memory is composed of 10,000 words of one byte. In one implementation variant, the photosensitive elements of the CIS or CCD photosensitive cells can be sensitive to rays of different colours, and to their constitution by a combination of red, green and blue. In another implementation example, the photosensitive cell is a matrix of 2000 photosensitive elements for analysis of the length for example, and of 2000 photosensitive elements for analysis of the width. Simultaneous longitudinal analyses are therefore possible along several longitudinal lines (T) of the stack (5), at different distances from one long side of the stack (5). In this case the analysis of the light rays reflected by the stack (5) is effected in two dimensions, in contrast to the other methods of implementation in a single dimension. The analysis effected in two dimensions allows several different longitudinal analyses of the stack (5), with the counting device being fixed, while the analysis effected in one dimension necessitates a movement of the stack (5) for example, in order to perform several different longitudinal analyses.

The information representing the light levels, stored in memory in digital form for example, are displayed in the form of a graph, as in FIGS. 12 and 13, and show variations in the light levels. The graph displays peaks showing the maxima and dips showing the minima of the signal obtained from the electronic circuits associated with the photosensitive cells. The processing resources are used to analyse these variations by, for example, processing all of the values taken in the order of their position. As an example, the pixel furthest to the right is processed, and then the next, progressing toward the left, and so on. A processing algorithm, represented in FIG. 14, is based, for example, on the comparison of at least two successive values in order to determine the direction of variation of the curve. Processing of the data representing the light level, stored in memory, will be described in detail below.

The stack (5) of thin products (1, 2) is composed, as shown in a manner which is non-limiting in FIG. 1, of elements (2) to be counted and separation elements (1), stacked side by side, placed standing on their bottom edges. The elements are placed facing in the same direction, in a manner which is non-limiting. Separating elements (1) are illustrated, in a manner which is non-limiting, in FIGS. 2 to 6. The mark (B1; B2, B3; B4; B5) of a separating element (1) is located by a CIS module (3, 3a, 3b, 3c, 3d) or a CCD camera (8) in association with the processing and memorising resources. This very precise mark (B1; B2, B3; B4; B5) is effected, for example, by a laser printing technique. The mark (B1; B2, B3; B4; B5) is placed on the top edge of the separating element. In the stack (5), this part is illuminated by the lighting resources, and is visible to the detection resources. In another method of implementation the mark is placed on any edge that is not hidden from lighting resources, and that is visible to the detection resources. In another method of implementation, all the edges of a thin product include a specified visual mark that can be detected by the detection resources associated with the processing resources.

In one implementation example, as illustrated by FIG. 7, the device is composed of one CIS module (3) projecting a beam of light rays (6). The light rays (6) are projected onto the stack (5) of thin elements (1, 2), contained in the container (4), in a longitudinal direction, forming a luminous line (T) on the stack (5). In another implementation example, shown in FIGS. 8 and 9, the device includes three CIS modules (3a, 3b, 3c) combined so that the light rays (6a, 6b, 6c) and the modules (3a, 3b, 3c) cover the whole length of the stack (5). The CIS modules (3a, 3b, 3c) are placed so that the processed zones partially overlap. In addition, the modules are inclined so that the illuminated zones are aligned. Modules 3a and 3c are inclined at angle i1 in relation to the vertical, and module 3b is inclined at angle i2 in relation to the vertical. The modules are inclined so that the intersection of the flat light beams (6a, 6b, 6c) with the stack (5) forms a single luminous line (T).

In one implementation variant (not shown), the CIS modules are not inclined, the longitudinal analysis being effected in several segments, the sum of whose lengths is at least equal to that of the stack (5). An initialisation stage is used to determine the relative positions of the CIS modules.

In another implementation example, shown in FIG. 10, the device includes only a single CIS module (3d) which moves in relation to the stack (5) to several positions (PO1, PO2, PO3) in a longitudinal direction. This module (3d) covers the full length of the stack (5), after several movements and several stops at given positions (PO1, PO2, PO3) in order to process, in each instance, another zone (ZO1, ZO2, ZO3) of the stack (5). The different positions (PO1, PO2, PO3) are chosen so that each zone partially overlaps the adjacent zone. The processing resources identify the signals corresponding to the overlaps and remove the doubled-up part of the signal. A calibration stage concerning the overlap zones is also described in French patent 2854476, in order to deal with the doubled-up data effectively.

In FIGS. 7, 8 and 9, the relative movement of the CIS module or modules (3, 3a, 3b, 3c) in relation to the container (4) is effected, according to one method of implementation, by a transverse movement (M4a) of the container, in relation to the longitudinal direction of the lighting, with the module or modules (3, 3a, 3b, 3c) being fixed. In another method of implementation, this same relative movement is effected by a transverse movement (M3a) of the CIS module or modules (3, 3a, 3b, 3c), with the container (4) being fixed. In the implementation example shown in FIG. 10, the relative movements take place along a transverse or longitudinal direction. A relative longitudinal movement is effected parallel to the longitudinal lighting in order to position the CIS module (3d) above the different zones of the container (4), with this movement (M4b and M3b respectively) being effected either by moving the container (4), with the CIS module (3d) being fixed, or by moving the CIS module (3d), with the container (4) being fixed. Once in position (PO1, PO2, PO3), a possible relative transverse movement (M3a and M4a respectively) of the CIS module (3d) in relation to the container (4) is effected, for example, perpendicular to the longitudinal lighting. In all cases, the relative transverse movements (M3a and M4a respectively) of the module or modules in relation to the container (4) involves several longitudinal analyses along different longitudinal zones of the stack (5).

FIGS. 11, 16 and 17 show a counting device with a camera (8), of the matrix or linear CCD type for example. The CCD camera (8) is associated, in a manner which is non-limiting, with two mirrors (9a, 9b) and a lighting resource (7). This type of device is described in detail in patent FR 2718550. The photosensitive sensor can be linear for example, and allows longitudinal analysis along a line (T). The associated lighting resources can, for example, be a fluorescent tube or diodes whose light rays are focussed or not. Several longitudinal analyses are effected along a given line (T) with different intensities of lighting for example.

In one implementation variant, several longitudinal analyses are effected along different lines (T1, T2, T3) for example, by a relative movement of the stack (5) in relation to the CCD camera (8) and to the lighting device. In one non-limiting example, the lighting resource (7) can be in the form of diodes whose rays are focussed by an optical device, and necessitate relative transverse movements in order to effect several different longitudinal analyses.

In the case where the lighting resource is effected by a fluorescent tube (7), all the top surface of the stack (5) is illuminated, but with different intensities. The zone nearest to the tube is illuminated with a light intensity that is higher than that of the more distant zones. This type of lighting of variable intensity, may or may not be combined with transverse relative movements in order to effect different longitudinal analyses along different longitudinal lines (T1, T2, T3), with different light intensities. One variant includes variation of the light intensity obtained by controlling the lighting resources through variation of the power.

In the case of a relative movement, either the detection resources (8, 9a, 9b) are fixed and the container (4) is mobile (M4a), or the container (4) is fixed and the detection resources (9a, 9b, 8) are at least partially mobile, with the mirrors (9a, 9b) and/or the CCD camera (8) being mobile.

In another method, of implementation, the photosensitive sensor of the CCD camera (8) is of the matrix type. This type of photosensitive sensor allows an analysis to be effected in two dimensions, along the length and the width of the stack (5). In the case, of a matrix-type photosensitive sensor, the transverse movements are not, necessary in order to effect several longitudinal analyses. For example, the CCD camera (8) can analyse the whole length of the stack (5), as shown in FIG. 16, in which the stack (5) is analysed over all of its length with a longitudinal movement (M8) of the CCD camera (8). Several lines, covering the whole length of the stack (5), are analysed, where the lines are very close to or adjoining each other at a distance of 5/100 of a centimetre for example, or more separated at a distance of one or several millimetres for example. The lines (T, T1, T2, T3) analysed are also illuminated at different light intensities.

The thin elements (1, 2) are stacked in a container (4) and are arranged so as to present the edge of greatest length toward the top of the container (4). The elements to be counted and the separating elements are placed side by side, in a manner which is non-limiting, with the front of one element facing the back of another. FIG. 1 shows an exploded view of thin elements (1, 2) stacked side by side, where the container (4) is not represented. The thin products are therefore places on their edge, oriented across in the container (4), meaning parallel to the small sides of the rectangular container (4). In the example of a personalisation card, a stack contains up to 500 cards. The counting device detects the edge of each product (1, 2) and thus determines the number (N) of products. One example of processing effected on the data is detection of the variation in the light levels. In FIG. 12, the data converted into the form of a graph show the luminosity as a function of position. In this example, a maximum will be the value of an electrical signal corresponding to a received light signal of high intensity in relation to the adjacent signals. Likewise, a minimum will be the value of an electrical signal corresponding to a received light signal of low intensity in relation to the adjacent signals. In a manner which is non-limiting, a maximum can be interpreted by the processing program as the middle of a product (2) to be counted, and a minimum is interpreted as the junction of two products (2) to be counted. The junction between two thin products (2) is in fact darker and the middle of a thin element is lighter. By inserting a separating element (1) into the sequence, the system can, in certain conditions, distinguish this element (1) distinctly from the other products (2). The analysis will be described in detail below.

A first example of this distinction consists of printing black stripes on a white background on the edge of a thin element, as shown in FIGS. 2 and 3. In another method of implementation, dark stripes of the same size are printed on a light background. In another implementation example, these stripes are light, white for example, on a dark background, in black for example. In a manner which is non-limiting, the separating element (1) has the same dimensions as the elements (2) to be counted. The advantage of having a single format for the dimensions of the thin products (1, 2), is that this then allows the processing of a complete stack (5) directly with a processing machine, with the dimensions of the separating elements (1) being accepted by the processing machine. In the method of implementation with black stripes on a white background, with the black stripes (B1) reflecting little light, the brightness of the rays reflected at this location will therefore be low. Since the white stripes reflect a lot of light, the brightness of the rays reflected at this location will be high. As a consequence, a controlled variation of the light levels in the zone corresponding to the separating element (1) is converted into the form of electrical signals of different intensities. The graphical representation of the intensity in accordance with the position in such a case corresponds, for example, to a signal (105) that displays a succession of maxima and minima, in which the peaks and the dips are close and of low amplitude. In another implementation example, a given value representing a peak or a dip in a signal corresponding to a given brightness and to a given product are placed in the memory of the processing system. During the execution of the processing program by the processing system, the search for and the identification of this value of a peak or a dip in the signal allows the identification of the corresponding product. In a manner which is non-limiting, the stored data, corresponding to the intensity of the rays reflected at a given point of the stack (5), are processed and analysed in accordance with their value or the value of the data corresponding to the adjacent or neighbouring points.

Take as a non-limiting example of a separating element (1), a card (1) for the separation of two series with a thickness (e) of 0.8 mm, with the card being inserted amongst other cards (2) of the same format as the personalisable cards for example. A distinctive pattern can be placed on the edge by a known printing process, in a manner which is non-limiting of the laser or inkjet type. A trace created by a laser process has a width of 0.04 mm for example. In addition, the counting device uses photosensitive elements that are capable of identifying such a trace after processing. Regarding the definition of the image, which is variable, one pixel represents a length of 0.05 mm for example. The width (e) of a 0.8 mm card is then equal to 16 pixels. A line (B1) with a width (e1) of 0.04 mm will appear during the processing as a variation of the colour and/or of the light intensity. The thicker the line, the more the variation will be visible, and this can be detected by the photosensitive element. For example, two black stripes (B1) on a white background, are placed on the edge of the card, in the direction of the length, also forming three white stripes, of identical width (d1, d2, d3), as shown in FIG. 2. Such a pattern can be created with known printing resources, and laser printing in particular. Secondly, this pattern can be detected by a CIS module or a CCD camera after processing of the data. The usual personalisable cards do not have this type of graphical elements, and these distinctive elements can be used to mark a separating card (1) between two small series of cards (2) to be counted. By virtue of a type of marking or the known order of the sequences, each sequence is located individually in the stack and is personalised according to its position.

Another non-limiting example of mark on a separating element is provided in FIG. 4. A black/white transition mark, is created by a black or dark stripe (B2) and a white or light stripe (B3), each occupying half (d4, d5) of the width (e) of the edge of a separating element (1). This transition is analysed and located by the counting device. The black stripe reflects little light, firstly because of its colour and secondly because of its large width. In contrast, the white stripe reflects a lot of light. The intensity of the rays reflected will therefore be high for the points located on the white stripe and low for the points located on the black stripe. This information, which is stored in computer form, shows the light intensity for each point located on this separating element. This information will therefore include a sequence of low values corresponding to the black stripe (B2), as shown between peaks 103 and 104, and then a sequence of high values corresponding to the white stripe (B3), as shown by peak 104. The distinction of the separating element comes, in a manner which is non-limiting, from the value of these extremums, from the relative position of the extremums and/or from the distance separating two extremums. The device thus designed is suitable in particular for the counting of cards that are transparent or with a low level of reflection such as cards of a dark colour for example. In one method of implementation, two longitudinal analyses are effected in a given position with a different intensity of light for each. The lighting is effected in a manner which is non-limiting by means of a fluorescent tube or electroluminescent diodes. This method of implementation is particularly suitable for the counting of elements that are very dark or very light or even transparent, in a stack. A first strong or weak light is applied for the analysis and correct recognition of the dark or light separating elements respectively, and thus to determine their position, and then, in the same position, a second weak or strong light is applied for the analysis and correct recognition of the light or dark elements to be counted respectively. Strong lighting is particularly suitable for translucent or transparent elements. For the counting of very dark elements to be counted, black separating elements with white lines are employed with advantage.

Other examples of distinguishing markings (B4, B5) are provided in FIGS. 5 and 6. FIG. 5 is an example of the use of a barcode, while FIG. 6 is an example of coding with dots, using dots of varying sizes. Regarding processing of the data, a separating element (1) is identified, for example, by the difference of position between two extremums of intensity. The fact that peaks or dips are close, indicates, for example, that it concerns the representation of a printed marking on a separating element (1) and not the representation of the junction between two elements to be counted. Another distinguishing element is the intensity recorded. Since this intensity is variable according to whether it represents a printed pattern or not or a particular colour. Analysis of the stack (5) is longitudinal and traverses the card (1) in a transverse manner, which is why the marking patterns (B1, B2, B3, B4) on the separating elements (1) are preferably in the direction of the length of the card (1), so that the processing and the analysis are identical irrespective of the longitudinal zone of the stack (5) on which the longitudinal analysis is effected. In the case where the marking patterns (B5) of the separating element (1) are not identical for different longitudinal zones, several longitudinal analyses are effected, on longitudinal zones that are preferably immediately adjacent, so as to effect a longitudinal and transverse analysis in two dimensions.

FIG. 12 is an non-limiting example of a graph, representing the signal supplied by the photosensitive elements and showing the variations in the light level in accordance with the position of products (1, 2) in the stack (5). The processing of the data is effected by means of a processing algorithm which has, amongst other things, as its entry parameters, the data representing the light level and the position in the data sequence. The value (voltage) of the signal representing the light intensity is converted, in a known manner, into digital levels in order to be stored in the form of computer code. The reflected light rays, focussed by a lens on the photosensitive cells, are converted into signals representing the intensities and corresponding to the pixels of a line or of CCD or CIS photosensitive matrix. The relationship between the distance between each pixel and the distance between the points analysed depends on the focussing lens and is known from the previous designs. The relative positions are therefore taken into account during the processing. A non-limiting example of a processing algorithm for the data, based on the search for the minimum and maximum levels of the signal, is provided in FIG. 14. The digital or analogue data obtained from the brightness sensors are processed in sequence, with the representative data being processed from the first end (x0) to the second end (x13). The algorithm looks for the local minima and the local maxima by comparing at least two consecutive values. When a minimum or a maximum is found, its value is stored, as well as its position and the order in which the minimum or the maximum has been detected in relation to the other local extremums. An example of memorisation is the use of a computer table with three fields such as the order, the position in the longitudinal analysis, and the value (voltage) of the signal representing the light intensity. This storage in memory allows the processing of the data associated with a longitudinal analysis with the inclusion of data processed previously.

The processing of the data corresponding to the signal represented by the graph of FIG. 12 is, for example, effected according to the algorithm represented in FIG. 14 and will now be described. A program for processing the data follows the different stages (Etp0 to Etp15) of this algorithm. The program starts with stage Etp0 which is the search for and identification of the value L0. This value (L0) corresponds to the brightness of the background of the device, converted by the photosensitive cells. The storage in memory of the value L0, allows this value to be associated with detection of the background. The processing program identifies a signal corresponding to the edge of the container by the search for and the identification of a first maximum (L2) followed by a first minimum (L1). The program then looks for and identifies a maximum (L2) at stage Etp1.

The processing program identifies a signal corresponding to a first element (2) to be counted by looking for a minimum (L1) followed by a maximum (L5), representing a peak (101) of the signal. The program looks for and identifies a minimum (L1) at stage Etp2, and then the program looks for and identifies a maximum (L5) at stage Etp3. The program then passes to stage Etp4, finds an elements (2) to be counted, and then starts a counting loop by passing to stage Etp5.

The processing program identifies signals corresponding to elements (2) to be counted, at positions x3 to x6, by looking for a minimum (L4) followed by a maximum (L5), corresponding to peaks (102 or 103) of the signal. The program looks for and detects a minimum (L4) at stage Etp5, then looks for and detects a maximum (L5) at stage Etp6, and then the program passes to stage Etp7 for registration of an element to be counted and finally passes to stage Etp5 at the start of the loop. The program executes this sequence (Etp6, Etp7, Etp5) four times in a row for example, and thus registers four elements (2) to be counted for example.

The processing program identifies a signal corresponding to a separating element (1), of the black/white transition type, by looking for a minimum (L3) followed by a maximum (L6), representing a peak (104) of the signal. Another distinguishing element is that the distance between the minimum and the maximum is less than or equal to half (e/2) of the thickness of the thin products (1, 2). The program looks for and detects a minimum (L3) at stage Etp5. The program then passes to stage Etp9 at which the program looks for and identifies a maximum (L6) and checks that the distance between the minimum and the maximum is less than or equal to half (e/2) of the thickness of a thin product. The program then passes to stage Etp10 for registration of a type 104 separating element and finally passes to stage Etp5 at the start of the loop.

The processing program identifies signals corresponding to elements (2) to be counted, at positions x8 and x9 as before. This means that the program passes, twice in a row for example, via stages Etp6, Etp7 and Etp5. The program thus registers two elements (2) to be counted and arrives at stage Etp5 at the start of loop.

The processing program identifies a signal corresponding to a separating element (1), with three equidistant black lines on a white background, by looking for a minimum (L4) followed by four consecutive maxima that are different from L5, with three minima interleaved between them, showing six variations of a given amplitude (V) between a maximum (L7) and a minimum (L8) and a distance between two of these maxima of less than the thickness (e) of a thin product. The program looks for and identifies a minimum (L4) at stage Etp5. The program then passes to stage Etp6 where the program looks for and identifies four consecutive maxima different from L5, with three minima (L8) interleaved between them, showing six variations of a given amplitude (V) between a maximum (L7) and a minimum (L8). The program checks whether the distance between two of these maxima is less than the thickness (e) of a thin product, and thence deduces that this signal corresponds to a separating element of the 105 type. The program then passes to stage Etp8 for registration of a separating element (1) of the 105 type. Then the program looks for and identifies a maximum (L5) at stage Etp15, and finally the program passes to stage Etp5 at the start of the loop.

The processing program identifies a signal corresponding to a last element to be counted by looking for a maximum (L5) followed by a minimum (L1). The processing program identifies a signal corresponding to the second edge of the container by looking for a minimum (L1) followed by a maximum L2 followed by L0. The program looks for and identifies a minimum (L1) at stage Etp5, and then the program exits from the counting loop by passing to stage Etp11. The program then registers an additional element (2) to be counted and looks for and identifies a maximum L2. The program then passes to stage Etp12 and looks for and identifies L0, and then passes to stage Etp13 to validate the count. The program finally ends at stage Etp14.

In this example of the algorithm, the complete processing, with error handling, is not shown. In addition, the processing according to this algorithm necessitates that the first and the last element of the stack (5) should be an element to be counted. In the example in FIG. 12, a peak of the signal representing a element to be counted has a shape that depends on the nature of the element to be counted and also on the nature of the adjacent elements. Two types of separating element give two different types (104, 105) of peak. The signal peak (104) at the seventh position corresponds to a separating element (1) with a black-white transition (B2, B3), as shown in FIG. 4. The signal peak (105) at, the tenth position presenting given variations corresponds to an element with three longitudinal lines of the same width implying an identical amplitude variation in the light levels and therefore comprising data representing a separating element of the 105 type. A separating element with three black longitudinal stripes on a white background is represented in FIG. 3.

FIG. 13 shows another graph representing the signal obtained from electronic light sensors. In this example the peak (108) represents a signal corresponding to a separating element with two black stripes on a white background, as shown in FIG. 2. The peak (109) represents a signal corresponding to an element to be counted with a black or dark top edge. In this case, the separating element represented in FIG. 2, is used to detect the start of a series, and also allows better analysis of the peak (109). The peak (109) in fact includes a large and a small hump, and is more difficult to analyse. In this example, a separating element is placed at the beginning of the stack (5) and at the end of the stack (5). In another implementation example, the peak (108) serves to determine the thickness of a thin product to be personalised. A thin product can have a variable thickness in fact.

Different types of separating element can be used in accordance with the series to be counted, since several distinctive signs, capable of being processed and identified by the counting device, are possible. An implementation example using barcodes allows the distinguishing mark to contain information and therefore to specify the nature of the next series for example, or any other information. In another type of implementation, separating elements (1) with different natures are inserted into a stack (5), with each separating element being identified distinctly. In one implementation example, the type of a separating element depends on a protocol, in order to specify the nature of the following products (1, 2) in the stack (5). The following example of a protocol is suitable for a stack of three different types of card, namely type1, type2 and type3, with the protocol implying that:
type1 is preceded by a separating card with two narrow black lines on a white background, printed in the direction of the length, equidistant from one side and from the other line;
type2 is preceded by a separating card with a black stripe and a white stripe, printed in the direction of the length, with each occupying half of the width;
type3 is preceded by a separating card with a black stripe, printed on a white background in the direction of the length, distant from each of the sides, of a given length and of a given width.

Consider the use of the device for the counting of small series automatically. The creation of a stack of several series is illustrated, in a manner which is non-limiting, by FIG. 1. The operator places the small series of thin products (2) in order one after the other. Each small series is separated by a separating element (1), of a different appearance, at least regarding the edge, with the separating element (1) thus being identifiable from the other thin products (2). In this example, the operator provides the system with information specifying the nature of the small series for the follow-up of the processing. The operator then enters into the system the nature and the order of each series, without specifying the number of elements (N1, N2, N3, N4) of each small series. After the processing of the data, the counting device therefore supplies the following information: the number of series, their order in the container of products to be counted, the number of products of each small series and the position of each separating element. By storing the information supplied by the operator, concerning the nature of the products, the device associates the nature of the products with each series. Thus in the follow-up of the processing of the stack, another processing system downstream of the production line, receives data specifying the nature of each product (1, 2) and can therefore determine the personalisation or the verifications to be performed. The processing system downstream communicates with the processing resources of the counting device via communication resources in a known manner. The communication resources include, for example, a line or infrared or radio connection, and communication interfaces to suit the type of connection. According to a variant, the communication resources are media such as diskettes or hard disks, associated with the drives for these media. The separating elements (1) can be created with the same dimensions as a product (2) to be processed, and each separating element (1) can then be ejected during the processing, so that it can be re-used for example. The advantage of having the same dimensions in a stack is that the stack (5) is processed directly and in full by the machine operating on the products (2) to be processed. Processing is effected, for example, in different ways for a separating element (1) or a product (2) to be personalised, with the products (1, 2) being processed in sequence. The type of personalisation to be employed is also taken into account. This processing therefore takes place automatically and directly by inserting the container or the magazine containing the stack (5) into the processing system, or by transferring the stack (5) to another medium. A check can be effected by comparing the number (N1, N2, N3, N4) of products processed in each series or the number of products (N) processed from the full stack (5), with the number (N, N1, N2, N3, N4) of products counted by the counting device for small series.

Consider the example given in FIG. 1. This figure illustrates the following example; which is not intended to be limiting. A stack of N elements has been created. A first separating element (1) is stacked with a first series of N1 products (2) of type 1. Next in the stack is a second separating element (1) placed in front of a second series of N2 products (2) of type 2. Next in the stack is a third separating element (1) positioned in front of a third series of N3 products (2) of type 3. A fourth separating element (1) is then stacked in front of a fourth series of N4 products (2) of type 4. Finally a fifth separating element (1) is positioned at the end of the stack. By indicating the positions from 1 to N, the relations between the places of elements are as follows:
p1=1; p2=N1+p1+1; p3=p2+N2+1; p4=p3+N3+1; p5=N=p4+N4+1

The references p1, p2, p3, p4 and p5 indicate the place of each separating element (1). The counting device for small series, after computer processing, produces several results which are stored in a memory. In a manner which is non-limiting, these results are the total number of elements N and the place of each separating element (1) (p1, p2, p3, p4, p5). The number of products in each series is therefore deduced from these results. The operator knows the nature of each small series making up the stack and thus determines the nature of each element (1, 2) at a given position. In the case where the elements (1, 2) of the stack all have the same format and are processed by a personalising machine, the whole stack is processed directly if additional information on the nature of the series is supplied to the personalising machine. During the personalisation process, the first element is first ejected in a manner similar to defective elements. The products of the place equal to 2 to the place equal to p2−1 are processed according to type 1; the element at place p2, being a separating element, is ejected; the elements of the place equal to p2+1 to the place equal to p3−1 are then processed by the personalising machine according to type 2. The remaining elements are processed in the same way. The personalising machine will have processed N elements in all, with the processing effected being a function of their position in the stack. On exiting from the personalisation process, an identical insertion mechanism will interleave a separating element between two series in order to reconstitute the stack which can then be personalised physically by special printing for each batch or for several batches. Such a counting device can therefore be used to more easily personalise small series and to monitor these series individually during production by installing tools for counting and extraction of separating elements or for the insertions separating elements (1) at each critical position. In one method of implementation, with the aim of being identified in a personalising machine, the separating elements include distinguishing signs on one or both faces. A distinguishing pattern for the separating elements on one face is easy to achieve, and also allows identification at the moment of the processing of the stacks and thus allow correlation of the positioning information supplied by the counting device and the positioning information produced by the processing machine throughout the processing stage. According to another aspect of the invention, the same separating elements (1) are retained throughout the chain, and the position of these elements in the stack is used to blank out the personalisation operation on the digital personalising head or in the physical personalising station and to personalise the personalisable products (2) in the adjacent positions.

An implementation variant, as shown on FIG. 15, includes at least one transverse CIS module (3t) effecting transverse lighting, perpendicular to the longitudinal direction of the stack (5) for example. The transverse CIS module (3t) includes detection resources and lighting resources using a flat transverse beam which illuminates the stack (5) transversally. The transverse CIS module (3t) placed opposite to the stack (5) effects the analysis of the illuminated linear transverse zone. The analysis of the whole length of the stack (5) is effected by a movement (M3t) of the transverse module, along the longitudinal direction of the stack (5). The longitudinal movement (M3t) of the transverse CIS module (3t) is effected at a specified speed. The photosensitive cells of the transverse module convert the light energy of the rays reflected by the stack (5) and focussed on the photosensitive cells of the detection resources, into electrical signals which are representative of the light intensity. The processing resources of the counting device sample these signals and convert the analogue values of the electrical signals into computer codes which are representative of these analogue values, and places them in the storage resources. When the transverse CIS module has covered a zone that includes the whole length of the stack (5) with its lighting resources associated with its detection resources, the stack (5) will have been analysed over all of its length and over a zone of a specified width. Analysis in two dimensions thus allows several longitudinal analyses to be performed on the stack (5). These longitudinal analyses are effected along lines that are close together (T1, T2) or distant (T1, T3) by several millimetres.

It should be obvious to those who are familiar with the subject that this present invention can include methods of implementation in many other specific forms without moving outside the area of application of the invention as claimed. As a consequence, the present methods of implementation should be considered to be illustrations only, but capable of being modified within the area determined by the scope of the attached claims, and the invention should not be limited to the details given above.

1. A device for counting series of thin products, stacked side by side, in a specified direction in a support device (4), with the stacked thin products constituting a stack, and where the device includes at least the following:
a device for lighting the stack, producing one or more light beams covering at least the whole length of the stack,
a detection device, with at least one detection circuit, including a multiplicity of photosensitive elements, and at least one optical device, associated with the detection circuit, that can be used to focus light rays reflected by the stack,
storage device,
the device for counting further comprising:
at least one separating element included in the stack at least between two adjacent series of thin products, where each separating element has at least one mark placed on at least one part of one of its edges, and where at least one part of the mark is illuminated by at least one lighting device and visible to at least one detection device;
a processing device receiving signals coming from the detection circuit or circuits and arranged to distinguish the visual limit of the thin products as well as the mark on the said separating element.

2. A counting device according to claim 1, wherein the processing device associated with the detection device performs a longitudinal analysis of the stack in order to determine the number of elements in each series constituting the stack or information that can be used to deduce the number of elements in each series constituting the stack.

3. A counting device according to claim 1, wherein the processing device associated with the associated with the detection device performs a longitudinal analysis of the stack in order to determine the position of each separating element in the stack.

4. A counting device according to claim 2, wherein a CIS module, positioned longitudinally and opposite to the stack constitutes the lighting device and the detection device, with the CIS module being at least equal in length to that of the stack, or the CIS module effects movements in the longitudinal direction of the stack opposite to a zone covering at least the whole length of the stack in several stages.

5. A counting device according to claim 2, further comprising a multiplicity of CIS modules positioned longitudinally and opposite to the stack, where each CIS module includes detection device and device for illumination by means of a flat beam in the specified direction, with the sum of the lengths of the CIS modules being at least equal to the length of the stack.

6. A counting device according to claim 5, wherein the CIS modules illuminate the stack along a line of light, with each CIS module being inclined at a determined angle so that its flat light beam falls upon this line.

7. A counting device according to claim 2, wherein the lighting device includes at least one focusing device and a multiplicity of electroluminescent diodes producing a flat beam in the specified direction, and wherein the detection device includes two mirrors and a CCD camera, with the part of the stack illuminated by the lighting device being reflected toward the CCD camera by the mirrors.

8. A counting device according to claim 2, wherein the lighting device includes a fluorescent tube illuminating the top face of the stack, and wherein the detection device includes two mirrors and a CCD camera, with part of the illuminated zone of the stack being reflected toward the CCD camera by the mirrors

9. A counting device according to claim 4, further comprising a device for relative transverse movement of the support device in relation to the detection and lighting device, allowing a multiplicity of longitudinal analyses of different zones of the stack.

10. A counting device according to claim 8, wherein the detection circuit of the CCD camera is composed of a matrix of photosensitive elements whose width allows the execution of a multiplicity of longitudinal analyses of different zones of the stack.

11. A counting device according to claim 2, further comprising at least one transverse CIS module, positioned transversally and opposite to the stack, with the said transverse CIS module including a detection device and a device for illumination by means of a beam covering at least one part of the width of the stack, with said transverse CIS module effecting a movement in the specified direction, opposite to a zone covering at least the whole length of the stack.

12. A counting device according to claim 11, characterized in that the transverse CIS module includes a multiplicity of photosensitive elements placed transversally in relation to the stack, that can be used to effect a multiplicity of longitudinal analyses of different zones of the stack.

13. A counting device according to claim 4, wherein the mark on a separating element is placed on its edge, in the form of two dark or light stripes, on light or dark backgrounds respectively, with these stripes being of specified thickness, of the same length as the separating element, distant by an equal length firstly from one long side of the separating element and secondly from the other stripe.

14. A counting device according to claim 4, wherein the mark on a separating element is placed on its edge, in the form of several dark or light stripes on light or dark backgrounds respectively, these stripes being of specified thickness, of the same length as the separating element, and equidistant from each other or from one long side of the separating element and the adjacent stripe.

15. A counting device according to claim 4, wherein the mark on a separating element is placed on its edge, in the form of a dark or light stripe on light or dark backgrounds respectively, the stripe being of a specified thickness, of the same length as the separating element, and equidistant from the long sides of the separating element.

16. A counting device according to claim 4, wherein the mark on a separating element is effected by a black or dark stripe adjacent to a white or light stripe printed on the edge of the separating element in the direction of the longest length, of the same length as the separating element and each occupying one half of the width of the separating element.

17. A counting device according to claim 4, wherein the mark on a separating element is effected by a barcode and/or by a dot code, of the same length as the separating element.

18. A counting device according to claim 13, wherein the stack includes separating elements with different or identical marks.

19. A counting device according to claim 13, wherein at least one separating element includes a distinguishing pattern on at least one face, that can be identified by a personalizing machine.

20. A counting device according to claim 13, wherein a multiplicity of longitudinal analyses are effected on a given zone of the stack, with the lighting device producing one or more beams with a distinct given intensity for each longitudinal analysis.

21. A counting device according to claim 13, wherein the storage device stores the different coding configurations of the separating elements, with each configuration corresponding to an identifier for a series of thin products, and in that the processing device is used to compare signals coming from the detection circuit or circuits with the configurations stored in the storage device and to associate one of the identifiers of a series of thin products with at least one series in the stack.

22. A counting device according to claim 13, wherein the two black stripes, analyzed by the processing device, are used to determine the width of the edge of a thin product and/or a separating element.

23. Use of the counting device according to claim 21, wherein information is transmitted by the processing device via communication device to a processing system, for the personalization, downstream of a production line, where the transmitted information includes the number of elements in each series constituting the stack and/or information that can be used to deduce the number of elements in each series constituting the stack and/or the position of each separating element in the stack and/or the identifier for each series.

24. Use according to claim 23, wherein the processing system personalizes the products of the series, with the physical or software personalization operation to be applied to each element of a series being associated with the information transmitted by the processing device.

25. Use according to claim 23, wherein the processing system distinguishes the separating elements by means of the information transmitted by the processing device, ejects the separating elements before processing a new series, and stores them with a view to their reuse.

26. Use of the counting device according to claim 21, wherein since the stack is created with several types of separating element, where each type of separating element is chosen so as to identify one of the two series between which the separating element is inserted.

27. Use of the counting device according to claim 21, wherein a digital personalizing station, processing a series of thin products including an integrated circuit, allows storage, in the memory of the integrated circuit, of personalizing information for the use for which the product is intended.
